(19) United States
(12) Patent Application Publication
(10) Pub. No.: US 2003/0233471 A1
(43) Pub. Date: Dec. 18, 2003

(54) Establishing a call in a packet-based communications network

(76) Inventors: Julian Mitchell, Maidenhead (GB); Michael Roshko, Brentford (GB); Cedric Aoun, Boulogne Billancourt (FR)

Correspondence Address: William M. Lee, Jr., Lee, Mann, Smith,, McWilliams, Sweeney & Ohlson, P.O. Box 2786, Chicago, IL, 60690-2786, US

(21) Appl. No.: 10/173,058

(22) Filed: Jun. 17, 2002

(51) Int. Cl. G06F 15/173

(52) U.S. Cl. 709/238; 709/249

(57) ABSTRACT

In order for a voice call or other communication session to be provided between entities in two different address domains, at least one of which is private, then a media proxy has previously been used to forward media packets. The present invention provides a way in which such a media proxy can be eliminated from a call flow after the initial stages of the call. This is achieved in the case that a network address translator involved in the call has a particular characteristic, such as being a cone network address translator.

### FIELD OF THE INVENTION

The present invention relates to a method of establishing a call in a packet-based communications network. The invention is particularly related to but in no way limited to voice over internet protocol (VoIP) networks.

### BACKGROUND TO THE INVENTION

The term “communications point” is used herein to refer to an address and port combination.

The term “public communications point” is used herein to refer to an address and port combination in a public communications network. This address and port combination may have been the result of a translation process at an address translation node such as a network address and port translator (NAPT). In the case that a basic network address translator (NAT) is used according to Internet Engineering Task Force (IETF) request for comments (RFC) 3022 and 2663, then the public communications point comprises only an address which may be a translated address as the result of translation at a basic NAT.

The term “private communications point” is used herein to refer to either an address or an address and port combination in a private communications network.

The term “public address domain” is used herein to refer to a region of a communications network in which a particular addressing scheme is used to assign addresses to nodes in that region. Addresses of entities in a public address domain are reachable by other addressing domains which may or may not have registered internet addressing schemes. That is, a public address domain may or may not have a registered internet address scheme.

Packet-based communications networks typically comprise several different address domains. For example, a particular company or enterprise may have its own network which is connected to another network such as the Internet. This is illustrated in FIG. 1 which shows a network 10 of a first enterprise connected to a common network 11. Other enterprises may also have networks connected to the common network 11, such as enterprise 2 and its network 12 in FIG. 1. These different networks 10, 11, 12 typically each use a particular addressing scheme and number of addresses, one for each node within that network. Thus each network is an address domain.

The address domains may or may not overlap; that is, for two overlapping address domains, at least some of the addresses occur in both domains. In addition, an address domain may be either public or private with respect to other address domains. In the example shown in FIG. 1 an enterprise network 10 is private with respect to common network 11. That is, addresses of nodes within enterprise network 10 are not known to nodes within common network 11. However, common network 11 is public with respect to enterprise network 10. That is, addresses of nodes in common network 11 are known to nodes within enterprise network 10.

As is known in the art, address domains are connected via address translation nodes which act to associate or “translate” the address of an item in one domain into an address that is functional within another address domain. For example, one particular type of address translation node is a network address translator (NAT). Another example is a network address and port translator (NAPT). Both NATs and NAPTs are defined by the Internet Engineering Task Force (IETF) in RFC 3022.

Consider a situation in which a service provider wishes to provide voice over internet protocol or other similar services to enterprise 1. This is typically achieved using a control node (e.g. MGC1 in FIG. 1) which is part of the service provider's own network connected to the common network 11 via a proxy node 14. In order for a voice call or other communication session to be provided between entities in two different address domains, at least one of which is private, then it has been suggested to use a media proxy to forward media packets. It is not possible to send the packets directly between two endpoints because one of those endpoints is private with respect to the other. Instead, both endpoints send packets to a media proxy which matches up those packets as being for the same communication session and forwards them to the correct destinations. For example, see Internet Engineering Task Force (IETF) Internet Draft “Midcom-unaware NAT/Firewall Traversal” Sen et al September 2001.

For example, consider a voice call between MG1 and MG3 in FIG. 1. In that situation, media packets, that is packets containing voice or other user data for the call are sent from MG1 to the media proxy and then from the media proxy to MG3. In the reverse direction, such packets flow from MG3 to the media proxy and then from the media proxy to MG1 via NAT 1. This uses a port on the media proxy as well as other media proxy resources. Those resources and the proxy are used for the duration of the call. However, media proxy nodes are relatively expensive and have a limited number of ports. It is therefore desired to increase media proxy capacity in order that the number of calls which can be supported is increased.

Recently this problem has been considered in the STUN method as defined in IETF's internet draft “STUN—Simple Traversal of UDP Through NATs” Rosenberg et al. of 1 Mar. 2002. However, this requires modifications to be made at nodes in the enterprise network. Such modifications are expensive and time consuming to implement and are potentially disruptive for the customer or enterprise.

An object of the present invention is to provide a method of establishing a call in a packet-based communications network which overcomes or at least mitigates one or more of the problems mentioned above.

Further benefits and advantages of the invention will become apparent from a consideration of the following detailed description given with reference to the accompanying drawings, which specify and show preferred embodiments of the invention.

### SUMMARY OF THE INVENTION

According to an aspect of the present invention there is provided a method of operating a media proxy in a public address realm of a communications network in order to establish a packet-based call between two entities. At least one of the entities is in a private address realm connected to the public address realm by an address translation node. The method comprises the steps of:

accessing information about a characteristic of the address translation node at a location in the communications network;

receiving packets at the media proxy from the entity in the private address realm via a public communications point at the address translation node;

if the accessed information about a characteristic of the address translation node indicates that, for a plurality of communications each from a particular private communications point to a different location in the public network, those communications are always associated with the same translated public communications point at the address translation node, then forwarding information about the public communications point to at least one of the entities such that those entities are able to forward packets to one another without passing those packets via the media proxy.

For example, the entities can be media gateways in a voice over internet protocol network. However, this is not essential, the entities could be user terminals which connect directly to a packet-based network or any other suitable type of node between which it is required to set up a call. The packet-based call could be a voice call, a video call, a fax call, or a communication session in any other suitable medium provided that the communication is effected using a packet-based method.

The address translation node can be a network address translator (NAT), network address and port translator (NAPT), or other suitable node. This node may or may not have a particular characteristic which is required in order for the method to be effective. This characteristic is met in the case that the node is any type of cone NAT or cone NAPT as explained in more detail below.

In the case that a basic cone NAT is used according to RFC 3022 and 2663 then the public communication point is a translated address. That is basic NAT translates an address to another. In the case that NAPT is used then the public communications point is a translated address and port pair on the public side of the NAPT.

Information is accessed at a location in the communications network, such as a control node, about whether or not the address translator has the required characteristic. If it does then information is obtained from the received packets about the public communications point being used at the address translator. This information is forwarded to the entity which does not already have that information. For example, in the case that one entity is in a private address realm and one is in a public address realm, then the entity in the public address realm is sent the public communications point information. That enables the entity in the public address realm to send packets direct to the other entity without routing those via the media proxy. The entity in the private address realm is also able to send packets direct to the other entity without routing those via the media proxy. In this way the media proxy is eliminated from the call flow after the initial stages of the call. This provides the advantage that media proxy communications points are freed and processing resources at the media proxy are used more efficiently. This is achieved without the need to modify the entities between which the call is made (e.g. media endpoints) and without the need to modify the address translation node.

In one embodiment the characteristic of the address translation node is pre-specified. For example, a control node which controls calls to or from a plurality of entities, associated address translation nodes and media proxies has pre-specified information about each of the address translation nodes in its domain. This includes information about whether those address translation nodes are cone NATs for example.

In another embodiment the characteristic of the address translation node is dynamically determined. For example, the control node can be arranged to monitor the behaviour of address translation nodes in its domain to determine whether they are cone NATs.

For example, the address translation node is selected from a symmetric NAT, a full cone NAT, a restricted cone NAT and a port restricted cone NAT.

In one example the step of receiving packets at the media proxy comprises receiving real time protocol (RTP) packets at the media proxy.

For example, these packets contain speech signals as part of a voice call. However, this is not essential, any suitable type of protocol can be used for the packets.

In another embodiment both entities are in different private address realms, each of those private address realms connected to the public address realm by an address translation node. For example, the private address realms are enterprise networks for two different enterprises.

In this case the method further comprises repeating said step of receiving information at the media proxy for both of the address translation nodes and repeating said steps of receiving packets at the media proxy and of forwarding information for both of the entities. That is, the enterprise networks are each connected to the public address realm by an address translation node. Those nodes both have the required characteristic, for example, they are both cone NATs. In that case, packets are received at the media proxy from both entities and used to determine the appropriate public communications point to use at each address translation node. That information is communicated to control nodes and to the entities themselves as appropriate. This enables the entities to forward packets for the remainder of the call to each other directly rather than via the media proxy.

In a preferred embodiment the control node comprises two components, one arranged to control one of the entities and the other arranged to control the other entity. This can also be thought of as using two separate control nodes. For example, those control nodes can be media gateway controllers.

According to another aspect of the present invention there is provided a media proxy node for use in a public address realm of a communications network. The media proxy node is used in order to establish a packet-based call between two entities, at least one of which is in a private address realm connected to the public address realm by an address translation node. The media proxy node comprises:

an input arranged to receive packets at the media proxy from the entity in the private address realm via a public communications point at the address translation node;

a processor arranged such that if a characteristic of the address translation node indicates that for a plurality of communications each from a particular private communications point to a different location in the public network, those communications are always associated with the same translated public communications point at the address translation node, then information about the public communications point is forwarded to at least one of the entities such that those entities are able to forward packets to one another without passing those packets via the media proxy.

The invention also encompasses a computer program stored on a computer readable medium and arranged to control a media proxy node in a communications network such that the method described above is implemented.

The invention also encompasses a communications network comprising a media proxy node as described above.

According to another aspect of the present invention there is provided a control node for use in a packet-based communications network and arranged to control calls to or from a plurality of entities in its domain, at least some of said entities being associated with one or more address translation nodes and a media proxy, said control node having access to information about a characteristic of each of the address translation nodes, said characteristic being whether, for a plurality of communications each from a particular private communications point to a different location in the public network, those communications are always associated with the same translated public communications point at the address translation node. By enabling the control node to access this information, the present invention is enabled and the media proxy can be eliminated from the call flow after the initial call stages.

According to another aspect of the present invention there is provided a method of operating a control node as described above said method comprising the steps of:

receiving a request to establish a call to or from an entity in the control node's domain; and

accessing information about said characteristic of an address translation node associated with the entity.

The invention also provides for a system for the purposes of digital signal processing which comprises one or more instances of apparatus embodying the present invention, together with other additional apparatus.

The preferred features may be combined as appropriate, as would be apparent to a skilled person, and may be combined with any of the aspects of the invention.

### BRIEF DESCRIPTION OF THE DRAWINGS

In order to show how the invention may be carried into effect, embodiments of the invention are now described below by way of example only and with reference to the accompanying figures in which:

FIG. 1 is a schematic diagram of a communications network incorporating a media proxy according to the prior art;

FIG. 2 is a schematic diagram of a cone network address translator (NAT);

FIG. 3 is a schematic diagram of a communications network arranged to implement the method of the present invention;

FIG. 4 is a message sequence chart for a method according to a first embodiment of the invention;

FIG. 5 is a message sequence chart for a method according to another embodiment of the invention;

FIG. 6 is a flow diagram of an example of a method of operation of the media proxy of FIG. 3.

### DETAILED DESCRIPTION OF INVENTION

Embodiments of the present invention are described below by way of example only. These examples represent the best ways of putting the invention into practice that are currently known to the Applicant although they are not the only ways in which this could be achieved.

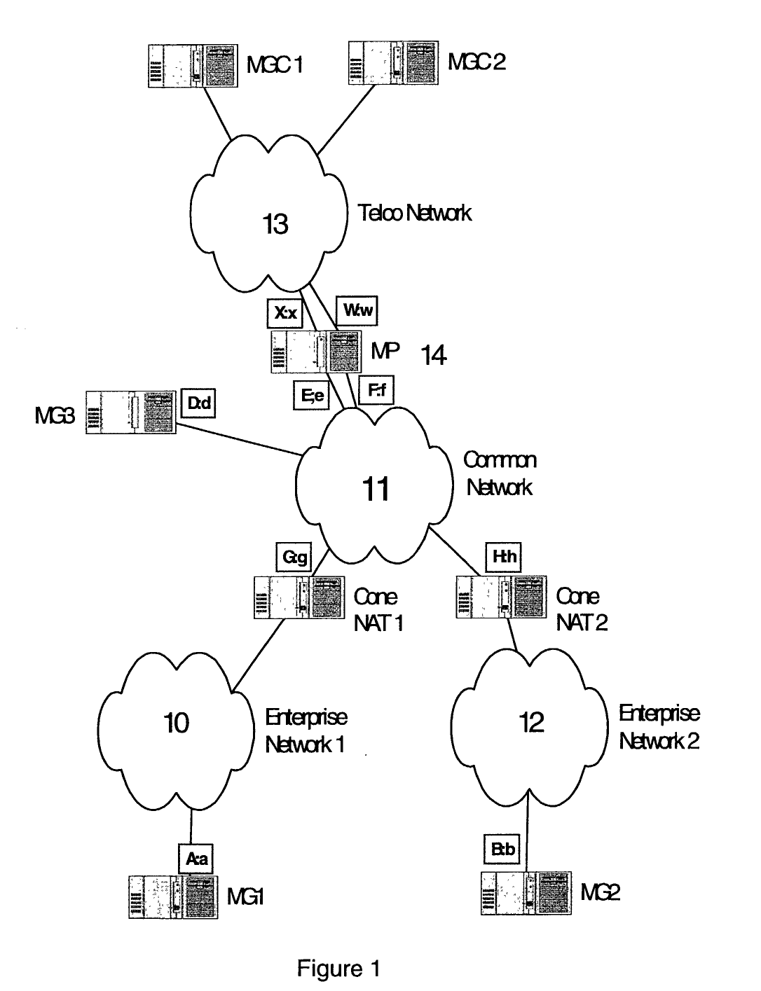

As described above with respect to FIG. 1 there is a need to increase the capacity of media proxies or other nodes which are used to forward media packets between entities in different address domains, where one of those address domains is private with respect to the other. This increase in media proxy capacity is required without modifications to existing address translator nodes or extensive modifications to other nodes in the different address domains.

The present invention enables this to be achieved by providing a new discovery mechanism at the media proxy. This discovery mechanism is operable in the case that the address translator between the two address domains has a particular characteristic. The discovery mechanism is executed during the initial stages of set-up of a communications session and once successful, the results are used to enable the media proxy to be by-passed for the remainder of the duration of the session or call.

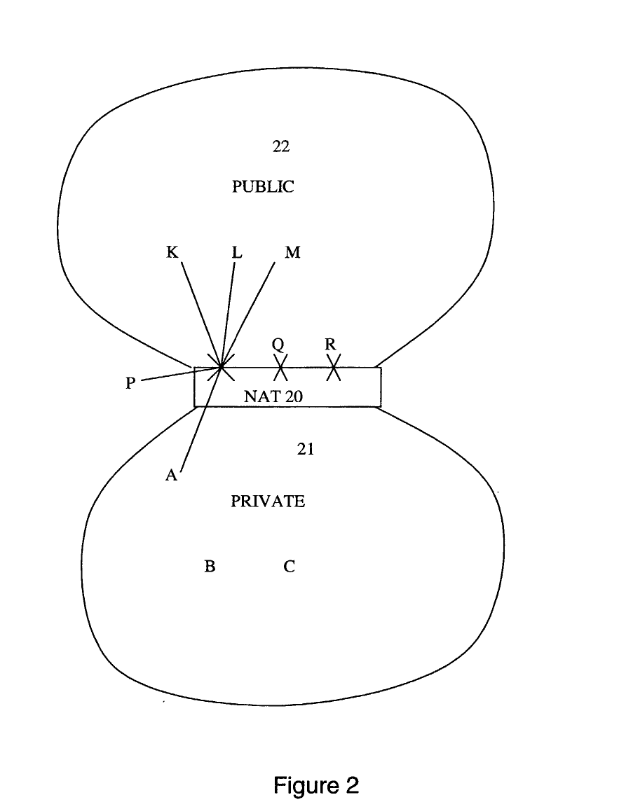

The particular characteristic of the address translator relates to how an entity in the private address domain is associated with a communications point that has a public address at the address translator node. The characteristic is that, all communications from a particular private communications point should always be associated with the same communications point with a public address at the address translator. In the case that the address translator is a NAT or NAPT this requirement is met where the NAT or NAPT is any type of cone NAT or NAPT. At least three types of cone NAT (or cone NAPT) exist and any of those types can be used in the present invention. Those three types are now described with reference to FIG. 2.

FIG. 2 is a schematic diagram of a cone NAT 20 connected between an internal or private address domain 21 and an external or public address domain 22. The NAT 20 has a plurality of communications points three of which are labelled P, Q, R in FIG. 2 although in practice there are typically many thousands of such communications points. Each of those communications points has a public address operable in the public address domain 22 and an associated port.

In the private address domain are a plurality of nodes, each with at least one communications point with a private address and three such nodes are indicated, A, B, C in FIG. 1. Similarly, in the public address domain there are a plurality of nodes, each with a communications point with a public address and three such nodes are indicated K, L, M. Consider node A in the private network 21 which has a communications point with a private address A. If a request is issued from that communications point to communicate with node K then a communications point, say P, at the NAT is used. Communication between nodes A and K takes place via communications point P so that K is able to contact A by sending messages to communications point P which has a public address.

In the case that NAT 20 is a cone NAT, then any other requests from node A to communicate with public nodes such as L, or M, also take place via communications point P. This is illustrated by the lines joining A, P, K, L and M in FIG. 2. If NAT 20 were not a cone NAT then communication between A and M might not take place via P.

Other types of cone NAT exist as defined in various IETF internet drafts. A summary is now given.

Full Cone NAT

This type of NAT operates such that all requests from the same internal address and port combination are mapped to the same external address and port combination. In this case any external host is able to send a packet to the internal host by sending the packet to a mapped external address.

Restricted Cone NAT

This type of NAT operates such that all requests from the same internal address and port combination are mapped to the same external address and port combination. However, in contrast to a full cone NAT, an external host with address P can send a packet to the internal host only if the internal host had previously sent a packet to address P.

Port Restricted Cone NAT

This type of NAT is the same as a restricted cone NAT except that that restriction includes port numbers. That is, an external host is able to send a packet with source address Z and source port R, to an internal host only if that internal host had previously sent a packet to address Z and port R.

The present invention is operable with any of the above mentioned types of cone NAT although the port restricted variant is restricted to NAPTs because basic NAT translates only an address to an address as mentioned above.

Thus in the case that a cone NAT (of any type) is present, if at a particular public address node, say K, messages are received from A via P it can be safely assumed that all communications for A should be sent to P. For a non-cone NAT this is not the case because communications from A could be via other communications points at the NAT. This feature of cone NATs is exploited in the present invention.

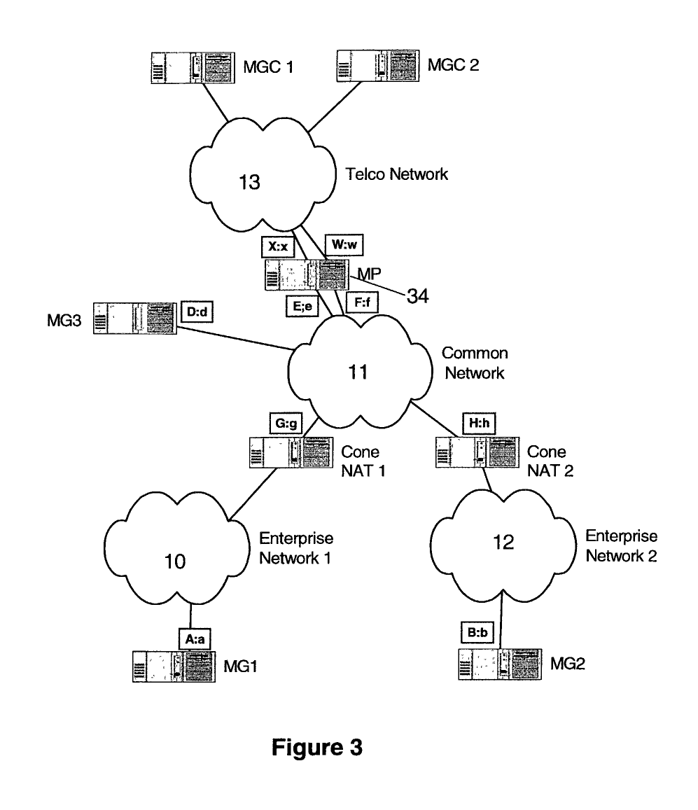

In the examples now described with reference to FIGS. 3 to 6 address translators which are cone NATs are used. However this is not essential, any suitable type of cone address translator may be used such as basic NAT, NAPT or NA(P)T.

FIG. 3 is a schematic diagram of a communications network arranged to implement the method of the present invention. FIG. 3 is similar to FIG. 1 and corresponding components are labelled with corresponding reference numbers. However, in FIG. 3 a media proxy 24 is arranged to carry out the method of the present invention and at least NAT 1 is a cone NAT of any suitable type as discussed above. In addition, control nodes MGC1 and MGC2 are arranged to access pre-specified information about address translators in their domain and whether those address translators have the particular characteristic mentioned above. Alternatively, at least one of those control nodes is able to determine whether particular address translators have the particular characteristic.

Each control node MGC1, MGC2 is arranged to control call flow for a plurality of endpoints that can be said to be in that control node's domain. In the example of FIG. 1, MGC1 is arranged to control call flow for node MG1 and other endpoint nodes within enterprise network 1 whilst MGC2 is arranged to control call flow for node MG3 and other endpoint nodes within common network 11.

It is not essential to use two separate control nodes MGC1, MGC2 as shown in FIG. 2 however. It is also possible to incorporate the functions of MGC1 and MGC2 into a single node. Any suitable control nodes can be used to control call or communication session flow and in one particular example, media gateway controllers are used as defined in IETF RFC 2805.

The invention also covers situations where the control node (e.g. MGC1) controlling a NATTed end point (e.g. MGW1) can control a media proxy if applicable. This removes the need to inform another controller (e.g. MGC2) that its controlled end point is behind a NAT and that the other controller should insert a media proxy. This situation arises for example where two administrative authorities owning different voice over internet protocol (VoIP) networks wish to communicate. In that situation no network topology information (for example that a NAT is traversed) should be provided to the other network. In that case each VoIP network is responsible for providing a reachable address (and port in the case a non-basic NAT) to the other VoIP network.

In the example shown in FIG. 3 the endpoint nodes MG1, MG2, MG3 are media gateways as defined in IETF RFC 2805 although this is not essential. Any suitable node which performs the function of allowing user terminals to access the communications network and obtain services provided by a service provider via control nodes MGC1, MGC2 can be used.

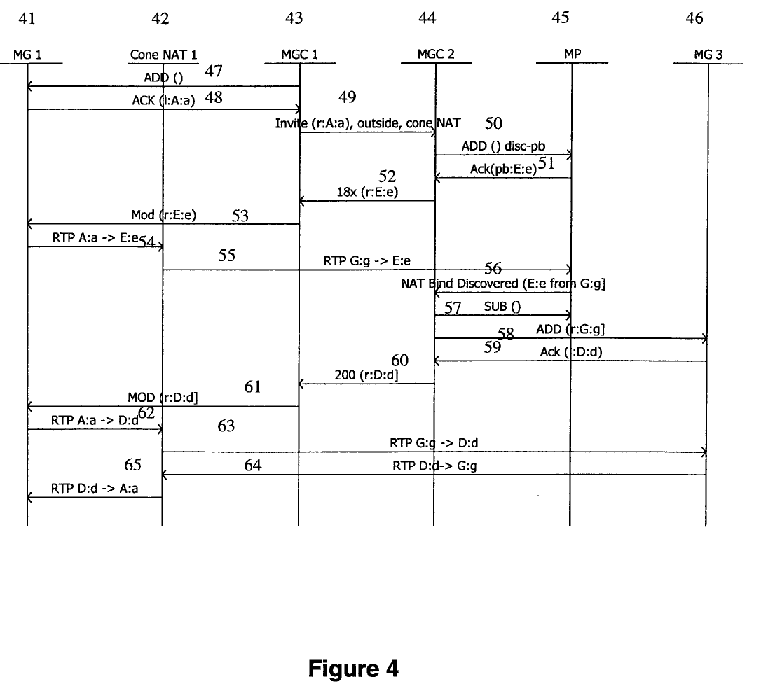

An embodiment of the present invention is now described with reference to FIG. 4 which is a message sequence chart. Each vertical line in FIG. 4 represents an entity in the communications network arrangement of FIG. 3. Line 41 represents media gateway 1 (MG1), line 42 represents cone NAT 1, line 43 represents media gateway controller 1 (MCG 1), line 44 represents media gateway controller 2 (MGC2), line 45 represents media proxy 34 and line 46 represents media gateway 3. Horizontal arrows between vertical lines in FIG. 4 represent messages sent between the entities. The relative vertical position of those horizontal arrows indicates the chronological order in which the messages are sent.

Consider the situation in which a voice over IP call is to be set up between media gateway 1 and media gateway 3 in FIG. 1. Because media gateway 1 is in a private network with respect to media gateway 3 then media proxy 34 is used to match up message streams from those two entities and forward those to the correct destinations as mentioned above. However, the present invention enables the media proxy to be avoided after the initial stages of the call.

A user at a terminal makes a request to set-up a call and a call set-up request is sent from the media gateway associated with the user terminal to the appropriate control node. In this example, the control node is MGC1. That control node therefore receives information about the identity of the originating media gateway and the call destination. Consider that the originating media gateway is MG1. The control node MGC1 sends a message to that media gateway MG1 to initiate the call set-up and this message is shown as arrow 47 in FIG. 4. The media gateway allocates a communications point for the call and sends information about the private address (A) of that communications point to the control node MGC1. This is indicated by arrow 48 in FIG. 4.

In the example illustrated in FIG. 4 any suitable type of messages can be used. However, in a preferred example the messaging between MGCs is based on session initiation protocol (SIP), (pseudo-SIP) and is preferably a generic inter-Media Gateway Controller Protocol. The messaging between MGs and MGCs, and between MGCs and MP is based on Megaco (pseudo-Megaco), and is preferably a generic Gateway Control Protocol. The protocol between MGs and NATs and between NATs and MPs represents RTP (Real Time Protocol).

The control node MGC1 knows that the address translator associated with media gateway 1 is a cone NAT. The control node gains this information from pre-specified information or by carrying out a discovery mechanism. The control node is therefore able to implement the method of the present invention. It sends a message (49 in FIG. 4) to the other control node MGC2 indicating that the NAT is cone NAT, that the call involves an entity in a private address domain and giving the port and private address details for the allocated communications point at media gateway 1.

The second control node MGC2 now sends a message 50 to the media proxy instructing it to discover the public address corresponding to the private address and port for MG1. The media proxy responds by allocating one of its own communications points for the call and giving the public address for that communications point, in this example port e with address E. Information about that communications point is sent to the other control node (see arrow 52 in FIG. 4) and also to media gateway 1 (see arrow 53 in FIG. 4).

Media gateway 1 now begins to send packets containing user data for the call. These are sent via the NAT (see arrow 54) to the media proxy (see arrow 55) and in the example shown are real time protocol (RTP) packets. When the media proxy receives those packets it is able to discover the public address at cone NAT 1 which corresponds to the private address used at the particular communications point at the media gateway 1. This is possible because the media proxy is expecting to receive packets from the private address originator at its communications point E:e and when those packets are received, the media proxy is able to obtain information in those packets indicating that they were sent from cone NAT public communications point G:g. This discovered information is then passed from the media proxy 34 to MGC2 (see arrow 56). MGC2 responds with message 57 to the media proxy and also sends a message 58 to the call destination MG3 informing MG3 about the public address to use at NAT 1 (which is G:g). MG3 sends an acknowledgement message 59 to MGC2 indicating that it has allocated a communications point, (port d with public address D) for use in the call. This information is sent from MGC2 to MGC1 (see arrow 60) and from there to MG1 (see arrow 61). The two endpoints MG1 and MG3 now have enough information to send packets for the call to each other directly rather than via the media proxy. This is indicated by arrows 62, 63, 64 and 65 in FIG. 4 which show media packets flowing from MG1 to the cone NAT 1, from there to MG3 and in the reverse direction from MG3 to the cone NAT 1 and then to MG1.

The method described above can also be extended to the situation in which both the origination and destination points for the call are in different private address domains. For example, the call may be between MG1 and MG2 in FIG. 3. In this situation, the media proxy is required to carry out discovery of the appropriate communications point (i.e. public address and port) at NAT 1 and also of the appropriate public address and port at NAT 2. NAT 1 and NAT 2 are both types of cone NAT.

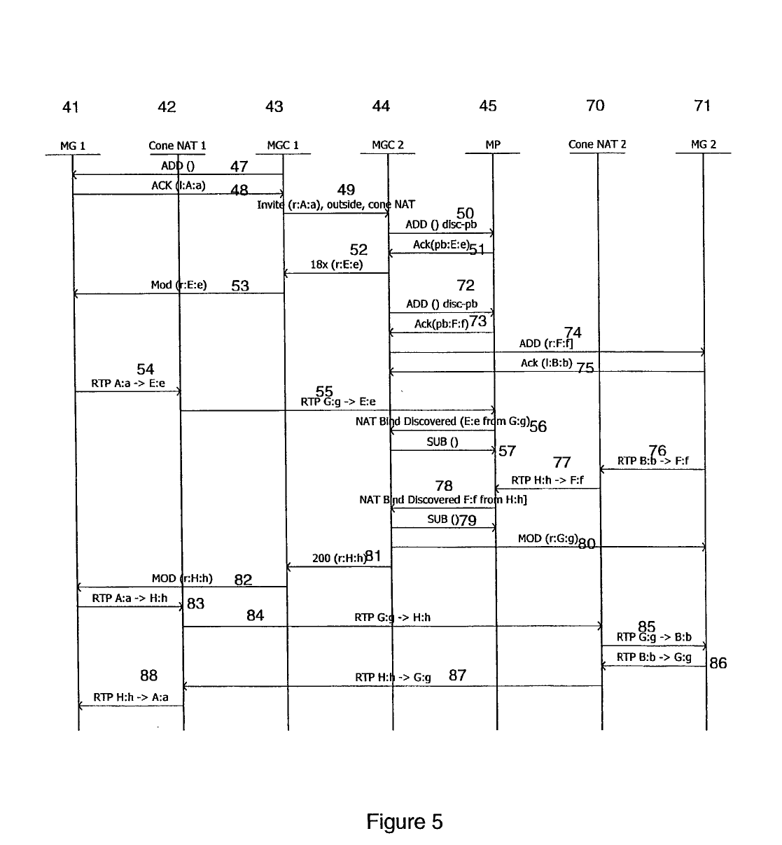

A message sequence chart for this situation is given in FIG. 5. FIG. 5 is similar to FIG. 4 but includes vertical lines representing cone NAT 2 (line 70) and media gateway 2 (line 71). The first sequence of messages 47 to 53 is the same as in FIG. 4. During this sequence, media gateway 1 informs MGC 1 of the communications point (port and private address of that port) which it has allocated for the call (see arrow 48). MGC1 knows that the NAT associated with MG1 is a cone NAT and informs MGC2 of this fact (see arrow 49). The media proxy is also informed of this information as a result of message 50 and is instructed to provide a communications point (public address to use at one of its own ports). MG1 is then informed which public address will be used at the MP (see arrows 51 to 53).

The same process occurs for MG2 and its associated NAT 2. This is illustrated by arrows 72 to 75. MGC2 asks the media proxy for a communications point to use at the media proxy for packets from MG2. In this example, communications point F is allocated. MG2 itself also allocates communications point B for the call in this example.

Steps 54 to 57 then proceed as in FIG. 4. During these steps, media packets are sent from MG1 to NAT 1 and from there to the media proxy communications point E (which was allocated in step 51). When the media proxy receives those packets it is able to determine from them that they passed via public communications point G at NAT 1. This discovered communications point information is then communicated to MGC2.

The same process then occurs for the other call half. That is, steps 76 to 79 give the equivalent result as steps 54 to 57. Media packets are sent from MG2 to the media proxy via NAT 2. NAT 2 is able to determine from information in those packets that the public communications point at NAT 2 being used is H in this example. This information is then communicated to MGC2 (see arrow 78).

Next the two endpoints (MG1 and MG2) are sent the information they need in order to bypass the media proxy. That is, MG2 is sent information about the public address G to use at NAT 1 (see arrow 80). Also, MG1 is sent information about the public address H to use at NAT 2 (see arrows 81 and 82). The two endpoints MG1 and MG2 are now able to send media packets to one another without sending those via the media proxy. This is illustrated by arrows 83, 84, 85 for the call half from MG1 to MG2 and arrows 86, 87, 88 for the call half from MG2 to MG1.

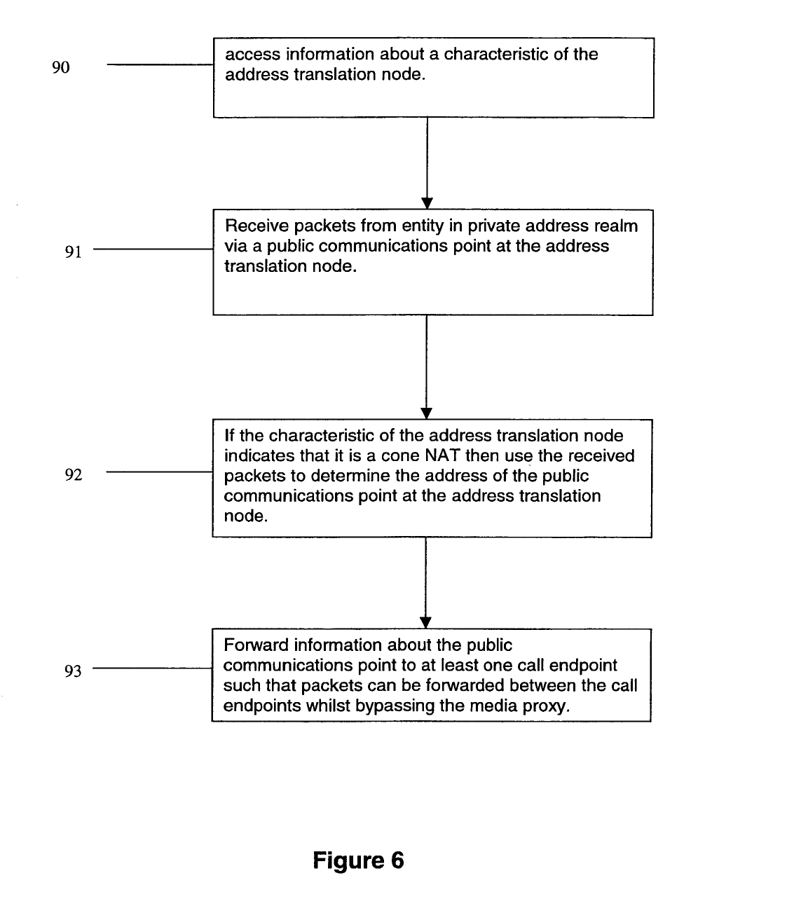

FIG. 6 is a flow diagram of a method of the present invention. This illustrates how information is accessed about a characteristic of the address translation node (box 90). Either the control node, the media proxy or both hold the knowledge about whether the address translation node has cone properties.

The media proxy receives packets (box 91) from the entity in the private address realm via a public communications point at the address translation node. For example, the entity in the private address realm is MG1 and the public communications point is G at NAT 1. This step of receiving packets is illustrated by step 55 and 77 in FIG. 5.

In the case that the NAT is a cone NAT then information about the public communications point (G or H in the example of FIG. 5) is forwarded to the entities at either end of the call (MG1 and MG2 in FIG. 5). That is, the media proxy discovers the NAT bind by providing the address (and port in the case of non-basic NAT) of the received datagram (packet) on the specified allocated address (and port in the case of non-basic NAT) handling the particular session.

Thus if the received information about a characteristic of the address translation node indicates that all communications from a particular private address are always associated with the same port with a public address at the address translation node, (see box 92) information is forwarded about the public communications point to at least one of the entities (MG1, MG2, MG3) such that those entities are able to forward packets to one another without passing those packets via the media proxy.

Any range or device value given herein may be extended or altered without losing the effect sought, as will be apparent to the skilled person for an understanding of the teachings herein.

1. A method of operating a media proxy in a public address realm of a communications network in order to establish a packet-based call between two entities, at least one of which is in a private address realm connected to the public address realm by an address translation node said method comprising the steps of:
(i) accessing information about a characteristic of the address translation node at a location in the communications network;
(ii) receiving packets at the media proxy from the entity in the private address realm via a public communications point at the address translation node;
(iii) if the accessed information about a characteristic of the address translation node indicates that, for a plurality of communications each from a particular private communications point to a different location in the public network, those communications are always associated with the same translated public communications point at the address translation node, then forwarding information about the public communications point to at least one of the entities such that those entities are able to forward packets to one another without passing those packets via the media proxy.

2. A method as claimed in claim 1 wherein said location is a control node which is arranged to control at least one of the entities.

3. A method as claimed in claim 1 wherein the characteristic of the address translation node is pre-specified.

4. A method as claimed in claim 1 wherein the characteristic of the address translation node is dynamically determined.

5. A method as claimed in claim 1 wherein the address translation node is selected from a network address translator (NAT) and a network address port translator (NAPT) and the characteristic of the address translation node is that the NAT or NAPT is any suitable type of cone NAT or NAPT.

6. A method as claimed in claim 1 wherein said step (ii) of receiving packets at the media proxy comprises receiving real time protocol (RTP) packets at the media proxy.

7. A method as claimed in claim 1 wherein said communications network is a voice over internet protocol communications network.

8. A method as claimed in claim 1 wherein said step (i) of receiving information at the media proxy comprises receiving that information as part of session initiation protocol (SIP) messages.

9. A method as claimed in claim 1 wherein both entities are in different private address realms, each of those private address realms connected to the public address realm by an address translation node.

10. A method as claimed in claim 9 wherein said method further comprises repeating said step (i) for both of the address translation nodes and repeating said steps (ii) and (iii) for both of the entities.

11. A method as claimed in claim 1 wherein said forwarded information about the public communications point is forwarded via a control node which is arranged to control at least one of the entities.

12. A method as claimed in claim 11 wherein said control node comprises two components, one arranged to control one of the entities and the other arranged to control the other entity.

13. A method as claimed in claim 12 wherein said components are media gateway controllers.

14. A media proxy node for use in a public address realm of a communications network in order to establish a packet-based call between two entities, at least one of which is in a private address realm connected to the public address realm by an address translation node said media proxy node comprising:
(i) an input arranged to receive packets at the media proxy from the entity in the private address realm via a public communications point at the address translation node;
(ii) a processor arranged such that if a characteristic of the address translation node indicates that, for a plurality of communications each from a particular private communications point to a different location in the public network, those communications are always associated with the same translated public communications point at the address translation node, then information about the public communications point is forwarded to at least one of the entities such that those entities are able to forward packets to one another without passing those packets via the media proxy.

15. A computer program stored on a computer readable medium and arranged to control a media proxy node in a communications network such that the method of claim 1 is implemented.

16. A communications network comprising a media proxy node as claimed in claim 14.

17. A control node for use in a packet-based communications network and arranged to control calls to or from a plurality of entities in its domain, at least some of said entities being associated with one or more address translation nodes and a media proxy, said control node having access to information about a characteristic of each of the address translation nodes, said characteristic being whether for a plurality of communications each from a particular private communications point to a different location in the public network, those communications are always associated with the same translated public communications point at the address translation node.

18. A control node as claimed in claim 17 wherein said information is pre-specified.

19. A control node as claimed in claim 17 wherein said information is dynamically determined by the control node.

20. A method of operating a control node as claimed in claim 16 said method comprising the steps of:
(i) receiving a request to establish a call to or from an entity in the control node's domain;
(ii) accessing information about said characteristic of an address translation node associated with the entity.
